(19) United States
(12) Patent Application Publication
(10) Pub. No.: US 2006/0021987 A1
(43) Pub. Date: Feb. 2, 2006

(54) Pressurized flat conformal tank

(76) Inventor: John V. Smolik, Granada Hills, CA (US)

Correspondence Address: INGRASSIA FISHER & LORENZ, P.C., 7150 E. CAMELBACK, STE. 325, SCOTTSDALE, AZ, 85251, US

(21) Appl. No.: 10/909,114

(22) Filed: Jul. 29, 2004

(51) Int. Cl. F17C 1/00

(52) U.S. Cl. 220/581

(57) ABSTRACT

A vessel for containing a fluid under pressure comprises essentially flat parallel surfaces connected by hemispherical edge closures. Internal tension members are connected between the parallel surfaces to distribute the pressure of the fluid in the vessel. The shape of the vessel can be generally square, triangular, toroidal, or other variation to conform to an available space. The skin of the vessel, the hemispheric edge closures, and the internal tension members are typically fabricated from a high strength lightweight material, such as titanium.

### TECHNICAL FIELD

The present invention generally relates to pressure vessels, and more particularly relates to flat conformal pressure vessels.

### BACKGROUND

Historically, pressure vessels for applications such as spacecraft propellant tanks have been generally configured as spheres or deviations of spheres. This type of configuration has generally been considered optimal for high-pressure tank applications since the spherical shape tends to equalize the internal pressures against the tank enclosure. A spherical configuration can also provide a relatively lightweight and compact package for vessels containing liquids or gases under pressure.

One disadvantage of a spherical type of vessel configuration is that it may result in wasted areas of space around the vessel within a typical non-spherical support structure. For applications where space is at a premium, such as in a spacecraft, a spherical tank mounted in a non-spherical support structure may not utilize the available space as efficiently as a different type of tank configuration that conforms more closely to the shape of the available space. The spherical shape may also result in a relatively high center of gravity of the vessel and associated support structure and thereby increase the load on the support structure. Moreover, any wasted volume in a spacecraft or similar application might otherwise be used advantageously, for example by enlarging a revenue-generating payload.

Accordingly, it is desirable to provide a general packaging configuration for pressure vessels that optimizes space utilization. In addition, it is desirable to provide a general packaging configuration with a relatively low center of gravity. Furthermore, other desirable features and characteristics of the present invention will become apparent from the subsequent detailed description and the appended claims, taken in conjunction with the accompanying drawings and the foregoing technical field and background.

### BRIEF SUMMARY

According to various exemplary embodiments, a general packaging configuration for pressure vessels is provided to optimize space utilization. One exemplary embodiment comprises a first member configured as a flat planar structure and a second member configured similarly to the first member. The second member is typically oriented parallel to the first member and is separated from the first member to form an internal space between the first and second members. In this embodiment, one or more tension members are disposed within the internal space and are connected between the first member and the second member. A hemispherical edge closure is typically configured to connect the edges of the first member to corresponding edges of the second member, thereby creating an enclosed vessel for containing a fluid under pressure. The shape of the first and second members can be optimally configured to conform to an available space.

### BRIEF DESCRIPTION OF THE DRAWINGS

The present invention will hereinafter be described in conjunction with the following drawing figures, wherein like numerals denote like elements, and

FIG. 1 is an exemplary illustration of a conventional spherical tank within a support structure;

FIG. 2 is an illustration of an exemplary embodiment of a flat conformal tank within a support structure;

FIG. 3 is an illustration of an exemplary embodiment of a pie-shaped (triangular) flat conformal tank;

FIG. 4 is an illustration of an exemplary embodiment of a square-shaped flat conformal tank; and

FIG. 5 is an illustration of an exemplary embodiment of a toroidal flat conformal tank.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present invention pertain to the area of pressure vessels such as propellant tanks for spacecraft applications. Traditionally, the configuration selected for this type of pressure vessel has been generally spherical, since a spherical shape has usually been considered optimal for containing liquids and gases under very high pressure (e.g., in an approximate range of about two hundred (200) to eight hundred (800) pounds per square inch (psi)). However, a spherical vessel configuration may not be an optimal fit for a typically non-spherical support structure, thus wasting a volume of space that could otherwise be utilized advantageously. Therefore, to improve the space utilization of a pressure vessel, a more versatile vessel configuration is proposed herein that can be conformed to the general shape of an available space.

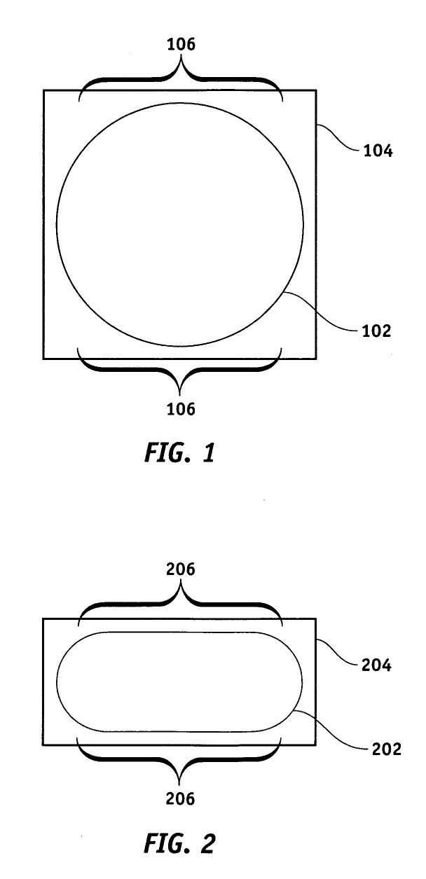

In FIG. 1, a simplified example of a traditional spherical pressure vessel 102 is illustrated within a generally rectangular/square support structure 104, as may be configured for a spacecraft or similar type of application. It will be appreciated that empty spaces 106 represent wasted volume between pressure vessel 102 and structure 104. This wasted volume (106) might otherwise be utilized advantageously, e.g., by providing additional volume for a payload for the spacecraft.

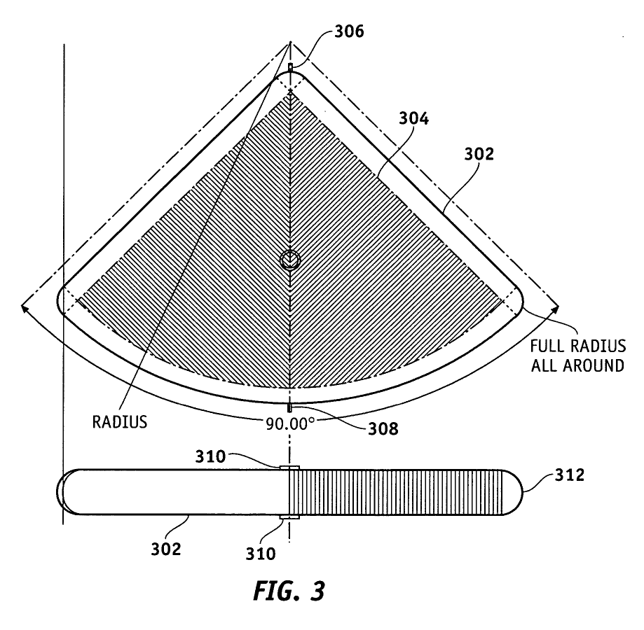

To reduce the amount of wasted volume between a pressure vessel and the surrounding support structure, a flat conformal pressure vessel can be configured in accordance with the available space. For example, an exemplary embodiment of a flat conformal pressure vessel 202 is shown within a generally rectangular support structure 204 in FIG. 2. In this embodiment, the empty spaces 206 between pressure vessel 202 and support structure 204 are typically smaller in volume than the empty spaces 106 in FIG. 1. That is, the non-spherical configuration of flat conformal pressure vessel 202 can provide a better fit into generally rectangular structure 204 than that of spherical pressure vessel 102 into generally rectangular structure 104. Moreover, a flat conformal vessel configuration will typically exhibit a lower center of gravity than an equivalent spherical vessel. As such, a support structure for a flat conformal vessel will typically experience a lower loading effect as compared to a support structure for a spherical vessel.

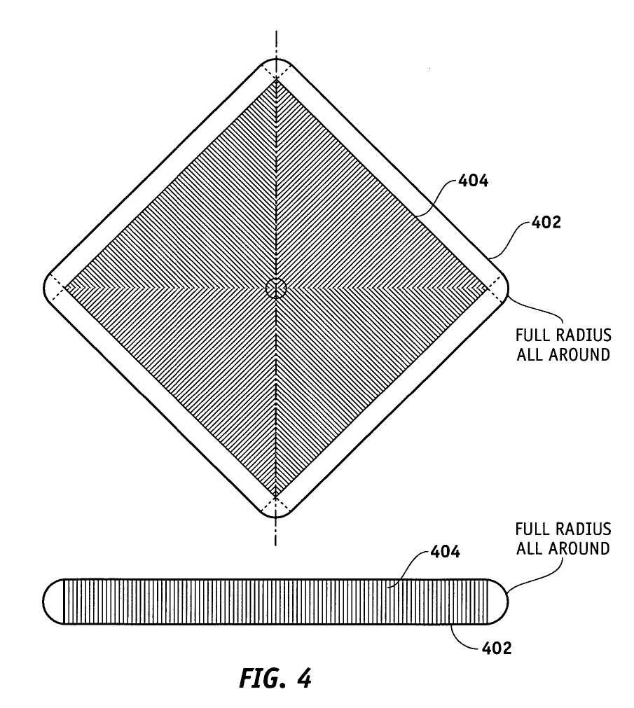

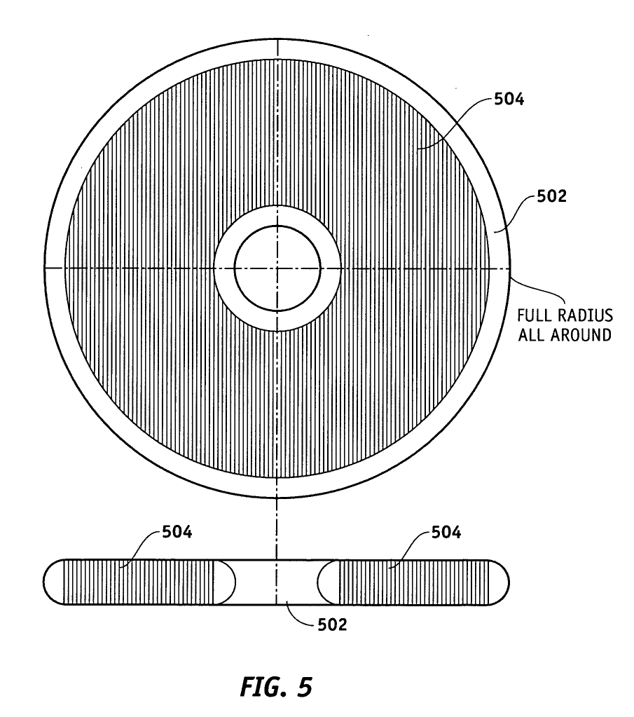

A flat conformal pressure vessel can be fabricated in various shapes, in order to optimize the configuration match between a pressure vessel and an available space. For example, as illustrated in FIG. 3, an exemplary flat conformal pressure vessel 302 is configured in pie-shaped (or triangular) form in order to conform to a pie-shaped or triangular space within a support structure (not shown). Similarly, an exemplary square-shaped flat conformal pressure vessel 402 is illustrated in FIG. 4, and an exemplary toroidal flat conformal pressure vessel 502 is illustrated in FIG. 5. It will be appreciated that the various flat conformal pressure vessel shapes illustrated in FIGS. 3, 4, 5 are merely exemplary and do not limit the types of configurations applicable to the concept described herein. Moreover, the exemplary flat conformal pressure vessels described herein can be oriented in any position.

In order for a flat conformal pressure vessel to accommodate a range of internal liquid or gas pressures equivalent to that generally contained in a spherical pressure vessel, the flat conformal pressure vessel is typically configured with internal tension members. These internal tension members are typically connected between the flat surfaces of a pressure vessel to distribute the fluid pressure within the vessel as equitably as possible. Exemplary embodiments of internal tension member configurations are shown diagrammatically as 304, 404, 504 in FIGS. 3, 4 and 5, respectively.

Exemplary embodiments of internal tension members 304, 404, 504 are typically configured as closely spaced thin walls oriented at an appropriate angle for optimal fluid channeling. For example, one embodiment can be configured with 0.002 inch walls spaced 0.25 inch apart, and angled at 45 degrees from the centerline of a pressure vessel, as depicted in the triangular and square shape embodiments of FIGS. 3 and 4. In the toroidal shape embodiment of FIG. 5, however, the internal tension members are configured in an arrangement parallel to the centerline of the pressure vessel. It will be appreciated that the particular configuration of the internal pressure members will be determined by factors such as pressure distribution, fluid channeling, heat dissipation, and the like.

Referring again to FIG. 3, triangular pressure vessel 302 is shown with a tube 306 for the passage of fluid, and a vent tube 308. In addition, support fittings 310 are secured to the flat sides of pressure vessel 302 for attachment to a support structure. It will be appreciated that the exemplary embodiment illustrated in FIG. 3 is merely one representation of many possible types of configurations for a flat conformal pressure vessel, as well as for the internal and external members and fittings. The main body or “skin” of pressure vessel 302 is typically fabricated from a high strength material such as titanium, and is sized to withstand a specified level of internal fluid pressure. For example, one embodiment of a flat conformal pressure vessel can be fabricated from 0.024-inch titanium to withstand an internal burst pressure of approximately three hundred ninety (390) psi. The considerations for the selection of pressure vessel skin material can also include such factors as compatibility with the pressurized fluid, weight, and sufficient flexibility to allow for a degree of expansion due to the internal fluid pressure.

Typically, the fluid and vent tubes (306, 308, respectively), the support fittings 310, and the internal tension members 304 are fabricated from the same material as the skin of the pressure vessel (302) in order to minimize the possibility of adverse chemical reactions between dissimilar materials, and also to simplify the manufacturing process. While a metal such as titanium has generally been found to exhibit the desired characteristics for this type of application, other materials or combinations of materials may also be considered if they meet the needs of a particular application.

In the exemplary embodiment of FIG. 3, the flat surfaces of pressure vessel 302 are joined together by hemispherical edge closures 312. The hemispheric shape of the edges is generally selected for optimal pressure distribution in order to provide a maximum strength closure. As indicated in FIG. 3, the exemplary embodiment is configured with a full radius all around the edges of pressure vessel 302. The alternate embodiments of pressure vessels 402, 502 shown in FIGS. 4 and 5, respectively, are also configured with full radius hemispherical edge closures in the same general manner as in the FIG. 3 embodiment of pressure vessel 302. Ancillary appendages such as fluid and vent tubes and support fittings are typically incorporated into the alternate pressure vessel configurations (402, 502), but are not shown in FIGS. 4 and 5 for clarity.

While the exemplary embodiments described herein refer to pressure vessels for spacecraft applications, the disclosed flat conformal packaging concept can also be adapted to other types of pressure vessel applications in confined and/or irregularly shaped spaces, as may be found in the aircraft and automotive industries, among others.

Accordingly, the shortcomings of the prior art have been overcome by providing an improved configuration for pressure vessels such as propellant tanks used in spacecraft applications. A versatile-shape flat conformal pressure vessel configuration is disclosed that can provide a more efficient utilization of packaging space than the more traditional spherical configurations. The flat conformal configuration typically incorporates internal tension members and hemispherical edge closures to enhance the internal pressure capabilities of the vessel. The shape versatility of the disclosed embodiments can result in a lower center of gravity for a flat conformal pressure vessel and associated support structure as compared to the center of gravity of a typical spherical vessel support structure, thereby reducing the relative loading of the conformal vessel support structure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A vessel for containing a fluid under pressure, comprising:
a first member configured as a flat planar structure;
a second member configured similarly to the first member and oriented essentially parallel to the first member, the second member being separated from the first member to form an internal space between the first and second members;
at least one tension member disposed within the internal space between the first and second members, the at least one tension member having a first end connected to the first member and having a second end connected to the second member; and
a hemispherical edge closure configured to connect the edges of the first member to corresponding edges of the second member, thereby creating an enclosed vessel for containing the fluid under pressure, wherein the planar shape of the first and second members is conformed to fit within an available space.

2. The vessel of claim 1 wherein the fluid is a liquid.

3. The vessel of claim 1 wherein the fluid is a gas.

4. The vessel of claim 1 wherein the first and second members are sized to withstand the pressure of the fluid in the vessel.

5. The vessel of claim 4 wherein the at least one tension member is configured to distribute the pressure of the fluid in the vessel.

6. The vessel of claim 1 wherein the planar shape of the first and second members is generally square.

7. The vessel of claim 1 wherein the planar shape of the first and second members is generally triangular.

8. The vessel of claim 1 wherein the planar shape of the first and second members is generally toroidal.

9. The vessel of claim 1 wherein the first and second members are fabricated from a material capable of expansion.

10. The vessel of claim 9 wherein the first and second members are fabricated from a material that is compatible with the fluid in the vessel.

11. The vessel of claim 10 wherein the first and second members, the at least one tension member, and the hemispherical edge closure are fabricated from the same material.

12. The vessel of claim 11 wherein the material is titanium.

13. The vessel of claim 1 wherein the vessel can be oriented in any position.

14. The vessel of claim 1 further comprising a tube for the passage of fluid.

15. The vessel of claim 1 further comprising a vent for the passage of air.

16. The vessel of claim 1 wherein the pressure of the fluid is in the approximate range of 200 to 800 pounds per square inch.
